(19) United States
(12) Patent Application Publication
(10) Pub. No.: US 2010/0135603 A1
(43) Pub. Date: Jun. 3, 2010

(54) BEARING SHELL AND METHOD FOR THE PRODUCTION THEREOF

(76) Inventors: Martin Klein, Walluf (DE); Christian Wolf, Wiesbaden (DE)

Correspondence Address: DICKINSON WRIGHT PLLC, 38525 WOODWARD AVENUE, SUITE 2000, BLOOMFIELD HILLS, MI, 48304-2970, US

(21) Appl. No.: 12/063,352

(22) PCT Filed: Aug. 8, 2006
(86) PCT No.: PCT/DE06/01380

§ 371 Date: Feb. 8, 2008

(30) Foreign Application Priority Data
Sep. 8, 2005 (DE) 10 2005 037 502.2

(51) Int. Cl. F16C 33/10; F16C 23/08

(52) U.S. Cl. 384/398; 384/206

(57) ABSTRACT

The invention relates to a bearing shell comprising a first exposed region and a second exposed region, said two exposed regions being formed on the inner surface of the two bearing shell ends. The oil grooves arranged in the two exposed regions are inclined in relation to the central line of the bearing shell, in the direction of flow of the lubricating oil. In this way, the lubricating oil is prevented from escaping in the axial direction in the exposed regions. The invention also relates to a method for producing such bearing shells.

### BACKGROUND OF THE INVENTION

1. Technical Field

The invention concerns a bearing shell with a first and a second crush relief area, whereby both crush relief areas are formed on the inner surface of the two ends of the bearing-shell, with a sliding-surface region between the two crush relief areas and with oil grooves that are placed at least in the crush relief area. The invention also relates to the use of such bearing shells and to a method for producing these bearing shells. The invention also concerns a bearing consisting of two bearing shells.

2. Related Art

Bearings are formed from two bearing shells that lie with parts of their surfaces on each other. In case of slight imprecisions, the partial surfaces do not lie exactly on each other, with the consequence that the inner edges of one partial surface can protrude inward. The counter-runner, namely the shaft, prevents this, which leads to additional wear. In order to prevent this, the bearing shells have so-called crush relief area on the ends of their bearing shells, by which a region adjoining the partial surfaces is meant in which the wall strength of the bearing shell is reduced. The disadvantage of such crush relief area is, however, that lubrication oil can leak out to the side, i.e., in an axial direction, whereby the lubrication-oil pressure drops during operation. This can lead to grinding of the shaft.

In order eliminate this problem, according to DE 101 83 292 A1, in the region in which the crush relief area is usually applied oil grooves are envisioned that are arranged parallel and directly adjacent (to one another). These grooves are produced by drilling, whereby ridges remain with peaks running between the grooves.

When these bearing shells are used, these peaks are worn down during running, so that a kind of crush relief area is generated by the initial wear.

The bearing shells are provided with oil grooves also in the region of the other sliding surfaces, which, however, have a lower depth than the oil grooves in the crush relief area.

The variously designed oil grooves must be produced on the finished bearing shells by drilling with correspondingly different tools, which is especially time-consuming.

### SUMMARY OF THE INVENTION AND ADVANTAGES

The task of the invention is to provide a bearing shell that has two crush relief areas and in which leakage of lubricating oil in the axial direction from the crush relief area is prevented. Another task is to make a corresponding production process available that enables grooves to be produced in the crush relief area in a simple way.

This task is solved with a bearing shell in which the oil grooves are oriented in the flow direction of the lubricating oil at an angle to the middle line of the bearing shell.

The middle line of the bearing shell runs in the middle in the circumferential direction.

By having the grooves run in the flow direction of the lubricating oil in the given direction of rotation of the shaft, the oil is led inward from the crush relief area and in this way oil leakage to the side is prevented. A V-shaped groove pattern is thereby created in the crush relief area.

When lubricating oil enters the first crush relief area and flows from there over the bearing shell to the second crush relief area, the oil grooves in the first crush relief area remove it in the direction of the partial surfaces from the middle line, and in the second crush relief area, the oil grooves run in the direction of the partial surfaces to the middle line. Attention must therefore be paid during the installation of the bearing shells that the direction of the oil grooves agrees with the direction of rotation of the shaft and thereby with the flow direction of the lubricating oil in the planned manner.

Advantageously, the oil grooves on both sides have their middle lines arranged parallel to one another and form an angle, β, with the middle line.

The angle of inclination, β, is preferably in the range 0<β<45°, especially in the range 0°<β<25° and especially in the range 0°<β<15°.

Preferably, the oil grooves extend at least from the first crush relief area to the region of the sliding surfaces. Lubricating oil flows from the adjacent shell in the first crush relief area and is accelerated at the end of the crush relief area at the transition into the region of the sliding surfaces. By having the oil grooves continue into the sliding surfaces area, a slowing of the lubricating oil is prevented, and it can enter the sliding surfaces area without delay. A slowing of the oil flow would lead to a pressure rise and favor an axial deviation and leakage of the oil from the crush relief area.

This outflow of lubricating oil in the direction of the sliding surfaces is further favored in that based on additional other version, the groove section in the region of the sliding surfaces has a greater depth than the groove section in the crush relief area. Preferred depths for the groove section are 0.03 mm in the crush relief area and 0.05 mm in the sliding surfaces area. The radius, R, of the groove bottom is preferably in the range of 0.1 mm≦R≦0.5 mm.

Preferably, the groove sections in the region of the sliding surfaces area themselves are at an angle β to the groove sections in the associated crush relief area.

Based on another version, all groove sections in the sliding surfaces area can be arranged parallel to one another.

The ends of the groove sections in the region of the sliding surfaces area preferably run tapered.

Based on another version, the groove sections can cover the entire region of the sliding surfaces area. In this way, the grooves of the first crush relief area are in a flow connection with the grooves of the second crush relief area, whereby the flow of lubricating oil over the entire bearing shell is additionally favored.

The groove sections in the crush relief area section preferably extend as far as the partial surfaces. By this means, the flow of oil from or to the adjacent bearing shell is favored, and leakage of oil to the side is reduced or prevented from each crush relief area.

Here, it can also be advantageous if the grooves in the first crush relief area are wider than in the second crush relief area.

The groove bottoms of the oil grooves can be either circular, parabolic, or elliptical.

Preferably, the groove distance, A, is greater than or equal to the groove width, B, whereby A is measured between the middles of two adjacent grooves. A>B is then preferred when it is desired to prevent rapid wear of the ridges between the grooves.

A preferred application of these bearing shells is envisioned for small connecting-rod bearings.

Small connecting-rod bearings means connecting-rod bearings with a width of <20 mm for automobile use and <40 mm for truck use.

The bearing according to the invention with two such bearing shells envisions that the first crush relief area of one bearing shell is arranged adjacent to the second crush relief area of the second bearing shell.

The method for producing bearing shells with a first and second crush relief area, with an area of sliding surfaces between the two crush relief area and with oil grooves envisions that boards are separated from strip stock. These boards are then converted into bearing shells, whereby the crush relief area are produced on the strip stock and the oil grooves are stamped into the strip stock, the separated board, or into the prefabricated bearing shells.

Stamping the oil grooves into the strip stock or into the boards is preferred, since this process step can preferably be included in the process of separating the boards from the strip stock. With a suitable cutting knife, additionally formed as a stamp for impressing grooves, it is possible to separate the boards and impress the grooves into the crush relief area surface in the same procedure step. A significant time saving is thereby achieved and the production process is clearly simplified.

### THE DRAWINGS

Example embodiments of the invention will be explained in the following by means of the drawings:

FIG. 1a shows the bearing shells in a perspective view,

FIG. 1b shows the two ends of a bearing shell in a perspective representation, broken apart into two parts for a complete view into the two crush relief areas,

FIG. 2 shows a section through a bearing with two bearing shells and a shaft,

FIG. 3 shows a view, A, of the bearing shell 1 shown in FIG. 2,

FIG. 4 shows a view, B, of the bearing shell shown in FIG. 3,

FIG. 5 shows a section along line C-C of the bearing arrangement shown in FIG. 2, according to a first embodiment,

FIGS. 6 through 8 show a section along line C-C of the bearing arrangement show in FIG. 2, according to another embodiment,

FIG. 9 shows an enlarged representation of a groove section in the sliding surfaces area of the bearing shell, and

FIG. 10 shows a schematic representation of the production method.

### DETAILED DESCRIPTION

In FIG. 1, the two ends 3a, 3b of bearing 1 are shown in perspective. A bearing shell 1 has at each of its ends 3a, 3b a partial surface 2, below which the wall thickness of the bearing shell is reduced, whereby a first crush relief area 4 and a second crush relief area 5 are formed. Between the two crush relief areas 4 and 5, there is a sliding surfaces area 7.

The middle line 10 in the circumferential direction has been drawn in. The flow direction of the lubricating oil is indicated by the arrow 11.

As can be seen in FIG. 2, in which a bearing consisting of two bearing shells 1,1′ is shown with a shaft 8 placed in the bearing, the flow direction 11 of the lubricating oil 9 is defined by the direction of rotation, n, of the shaft 8.

In the bearing shell 1, shown in FIG. 1, lubricating oil 9 flows first into the first crush relief area 4 and from there over the sliding surfaces area 7, to the second crush relief area 5.

In the first crush relief area 4, grooves 20a, 20b are arranged that run from partial surface 2 in the flow direction 11 to the middle line 10. Crush relief area 4 is divided by the middle line 10 into two halves 4a and 4b, in which oil grooves 20a or oil grooves 20b are arranged. Within these crush relief areas 4a, 4b, grooves 20a and 20b are oriented parallel to one another. Grooves 20a, 20b form an angle of inclination, with the middle line 10.

In the second crush relief area 5, which is likewise divided into two halves 8a, 8b by the middle line 10, oil grooves 30a, 30b are arranged in the direction from partial surface 2 to the middle line 10. Within the halves 8a, 8b, oil grooves 30a and 30b are arranged parallel to one another and likewise form an angle, β, with the middle line. Crush relief areas 4 and 5 are delimited by the limiting line 6a, 6b from the region of sliding surfaces 7.

In FIG. 3, a view, A, of bearing shell 1 of FIG. 2 is shown. The flow direction of the lubricating oil is indicated by the arrow 11.

In FIG. 4, a view, B, of bearing shell 1 shown in FIG. 3 is shown, which shows a top view of the second partial-surface region 8.

In FIG. 5, a section along line C-C through the bearing in FIG. 2 is shown. It should be seen that the first crush relief area 4 of bearing shell 1′ adjoins the second crush relief area 5 of the bearing shell 1. Because of the flow direction from the first bearing shell 1 to bearing shell 1′ and the orientation of oil grooves 30a, 30b and oil grooves 20, 20b, the lubricating oil flows from the end region to the middle, i.e., in the direction of the middle line 10, whereby a leak from the bearing shell 1 in the axial direction, i.e., in the direction perpendicular to the middle line 10, is prevented.

In FIG. 6, another embodiment is shown in which the oil grooves 20a, 20b of bearing shell 1′ in the first crush relief area 4 extend into the sliding surfaces area 7. Each oil groove 20a, 20b thus has a groove section 21 in the crush relief area 4 and another groove region 22 in the sliding surfaces area 7. The inclination of groove section 21 with respect to the middle axis 11 is also retained in groove section 22.

In FIG. 7, another embodiment is shown, in which groove sections 22 are arranged parallel to each other, in contrast to the embodiment of FIG. 6.

In order to improve the flow conditions in the transition from bearing shell 1 to bearing shell 1′, groove section 21 of the oil grooves 20a, 20b is formed wider in the first crush relief area 4 of bearing shell 1 than grooves 30a, 30b in the second crush relief area 5 of bearing shell 1.

In FIG. 8, another embodiment is shown, in which groove section 22 extends over the entire sliding surfaces area 7. Grooves 20a, 20b thereby stand in a flow connection with grooves 30a, 30b over groove section 22 in the flow direction.

In FIG. 9, the end region 23 of groove section 22 is shown enlarged. It should be seen that the groove has a circular groove bottom that runs into a peak.

In FIG. 10, the production process of the bearing shell according to the invention is shown schematically. Starting from a strip stock 40, the crush relief area 4 and 5 are etched first at the edges. Boards 42 are separated from this strip stock 40 along a separation line 41. In this separation process 42, with a suitable combined knife/stamp, the grooves 20a, 20b, and 30a, 30b are impressed in the corresponding crush relief area 4 and 5. The separated boards 42 then have both the crush relief area 4 and 5 and also the associated grooves 20a, 20b, 30a, 30b. Then the shaping bearing shells and, if necessary, the subsequent drilling of the bearing shells follow.

1. A bearing shell with a first crush relief area and a second crush relief area, whereby the two crush relief areas on the inner surface of the two bearing-shell ends are formed, with a sliding surfaces area between the two crush relief areas and with oil grooves, arranged at least in the crush relief areas, wherein the oil grooves in the flow direction of the lubricating oil are oriented at an inclination to the middle line of the bearing shell.

2. A bearing shell according to claim 1, wherein the oil grooves are arranged parallel to one another on both sides, next to the middle line, and form an angle β with the middle line.

3. A bearing shell according to claim 2, wherein for the angle of inclination β, 0<β<45° is true.

4. A bearing shell according to claim 2, wherein for the angle of inclination β, 10°<β<30° is true.

5. A bearing shell according to claim 2, wherein for the angle of inclination β, 15°<β<25° is true.

6. A bearing shell according to claim 1, the oil grooves extend at least from the first crush relief area to the sliding surfaces area.

7. A bearing shell according to claim 6, wherein the groove sections in the first crush relief area have a greater depth than the groove sections in the sliding surfaces area.

8. A bearing shell according to claim 6 wherein the groove sections in the sliding surfaces area have the same angle of inclination β as groove sections have in the associated first crush relief area.

9. A bearing shell according to claim 6, wherein all groove sections in the sliding surfaces area are arranged parallel to the middle line.

10. A bearing shell according to claim 1, wherein the ends of the groove sections run tapered.

11. A bearing shell according to claim 1, wherein the groove sections extend over the entire sliding surfaces area.

12. A bearing shell according to claim 1, wherein the groove sections in the crush relief areas extends to the parting surfaces.

13. A bearing shell according to claim 1, wherein the oil grooves in the first crush relief area are wider than the oil grooves in the second crush relief area.

14. A bearing shell according to claim 1, wherein the groove bottom of the oil grooves is one of circular, parabolic, or elliptical.

15. A bearing shell according to claim 1, the groove distance A is greater than or equal to the groove width B, whereby A is measured between the middle of two adjacent grooves.

16. A bearing shell assembly according to claim 1, wherein the bearing shell comprises a camshaft bearing for automobile or truck motors.

17. A bearing shell according to claim 1, wherein the bearing shell comprises a bearing shell for a small connecting-rod.

18. A bearing with two bearing shells according to claim 1, whereby the first crush relief area of the first bearing shell is arranged adjacent to the second crush relief area of the second bearing shell.

19. A method for producing bearing shells with a first and a second crush relief area, whereby the two crush relief areas are formed on the inner surfaces of the two bearing-shell ends, with a sliding surfaces area between the two crush relief areas and with oil grooves that are arranged, at least in the crush relief areas, in which boards are separated from a strip stock and then these boards are shaped into bearing shells, wherein the crush relief areas are produced on the strip stock and that the oil grooves are impressed into the strip stock, or into the separated boards or into the shaped bearing shells.

20. A method according to claim 19, wherein the oil grooves are impressed during separation of the boards.
